(19) United States
(12) Patent Application Publication
(10) Pub. No.: US 2024/0205469 A1
(43) Pub. Date: Jun. 20, 2024

(54) APPARATUS AND METHOD FOR PROCESSING CLOUD STREAMING LOW LATENCY PLAYBACK

(71) Applicant: SK Planet Co., Ltd., Seongnam-si (KR)

(72) Inventor: Ji-Yeon HWANG, Seongnam-si (KR)

(21) Appl. No.: 18/491,729

(22) Filed: Oct. 20, 2023

(30) Foreign Application Priority Data
Dec. 19, 2022 (KR) 10-2022-0178641

(51) Int. Cl. H04N 21/2343; H04N 19/70

(52) U.S. Cl. CPC H04N 21/2343; H04N 19/70

(57) ABSTRACT

Disclosed herein are an apparatus and method for processing cloud streaming low latency playback. The cloud streaming low latency playback processing method in a client apparatus according to an embodiment of the present disclosure may further include checking each piece of time information about decoded audio data and decoded video data to determine whether a time difference between the decoded audio data and video data, and adjusting one of a decoding speed of audio data and a decoding speed of video data when a time difference is greater than a preset threshold value.

### CROSS REFERENCE TO RELATED APPLICATION

This application claims the benefit of Korean Patent Application No. 10-2022-0178641, filed on Dec. 19, 2022, which is hereby incorporated by reference in its entirety into this application.

### BACKGROUND OF THE INVENTION

### 1. Technical Field

The present disclosure relates generally to a cloud streaming service, and more particularly to a technology for addressing a playback latency issue according to demultiplexing and synchronization by receiving audio data and video data in a separated state, and directly decoding and playing them back.

### 2. Description of the Related Art

According to the development of the computer network technology, the existing computing environment dependent on independent hardware performance of each terminal is evolving to a cloud computing type in which all computing resources on the network are used for providing a service corresponding to a request from the terminal.

Cloud computing may be defined as “on-demand outsourcing service of computing resources” over an information communication network such as the Internet. In the cloud computing environment, a service provider integrates data centers distributed in various places through the virtualization technology to provide users their needed services. The users use the services not by installing computing resources such as applications, a storage, an operating system (OS), the security or the like in their terminals, but by selecting as many services as they desire at a desired time on a virtual space generated through the virtualization technology.

In other words, cloud computing refers to a computing service that borrows computing resources such as hardware or software existing in an intangible form like cloud as much as needed and pays the fee for usage, which is a technology for integrating computing resources that are scattered at different physical locations using virtualization.

According to such cloud computing, a user may establish a connection to a cloud network through a user terminal for performing only network connection and basic calculation functions to perform jobs requiring large-scale storage apparatuses and high performance computing resources, and be provided with various services.

A cloud streaming service refers to a service based on such a cloud computing environment in which a server side executes a game, VOD, real-time broadcast content or the like and then the execution screen is streamed to a client to allow the client to perform only input and output. Accordingly, the user is enabled to use desired content regardless of the specification and performance of the client. In other words, the cloud streaming refers to a technology in which, without installing an application to a user's own client, the user may use the function of the application by requesting the server to execute the application and then receiving only the execution screen. This allows the user having the client with the low specification to be able to conveniently use an application requiring high specification or a large capacity of data.

In such a cloud streaming service, when a request input by the client is executed in a service apparatus connected with the client over a communication network and the result is transmitted and output to the client, the level of satisfaction and the service quality are lowered as latency from the user request to the reception and output of the result becomes longer.

Accordingly, it is required to provide a rapid response so that the user feels as if the content were executed or played back in the client.

However, for the cloud streaming service, there are various issues to be addressed including transmission bandwidth of a communication network, multimedia data processing capability of a terminal, synchronization or the like in video and audio data transmission of a moving image corresponding to the execution or playback result to the client over the network in a streaming manner. Such issues may increase the latency and lower the service quality.

Specifically, as the response to the request over the communication network, the client, having received a bitstream including the video and audio data, separates the bit stream into the video data and the audio data through demultiplexing, parses a header to decode the video and audio data, synchronizes the playback time of the video and audio data, and then outputs an image and voice through rendering. Here, the image and voice outputs are delayed by an amount of time required for the demultiplexing, synchronization or the like, and thus the latency of the user is increased.

Therefore, for reducing the latency of the user to improve the service quality, it is required to minimize the amount of time required for the demultiplexing and synchronization.

### SUMMARY OF THE INVENTION

Accordingly, the present disclosure has been made keeping in mind the above problems occurring in the prior art, and an object of the present disclosure is to minimize latency from a user request to reception of a response in providing a cloud streaming service.

In other words, the object of the present disclosure is to prevent image and voice outputs from being delayed by an amount of time required for demultiplexing, synchronization or the like to reduce the latency of the user by receiving separated video data and audio data and then directly decoding to output them.

However, the objects of the present disclosure are not limited to those described above and other issues unmentioned above will be clearly understood from the following description.

In accordance with an aspect of the present disclosure to accomplish the above object, there is provided a client apparatus, including a network interface configured to receive encoded audio data, encoded video data, and a control signal in a separated state, a first decoder configured to decode the encoded audio data output from the network interface, a second decoder configured to decode the encoded video data output from the network interface, and a control unit configured to control the first decoder and the second decoder based on the control signal output from the network interface, and control audio data and video data output respectively from the first decoder and the second decoder to be played back through a user interface.

The control unit may check time information about each of the decoded audio data and the decoded video data, and may control the audio data and video data output respectively from the first decoder and the second decoder to be played back through the user interface when a time difference between the decoded audio data and the decoded video data is less than or equal to a preset threshold value.

The control unit may check time information about each of the decoded audio data and the decoded video data, and may adjust a decoding speed of one of the first decoder and the second decoder when a time difference between the decoded audio data and the decoded video data is greater than a preset threshold value.

The client apparatus may further include a first buffer configured to store the encoded audio data output from the network interface, a second buffer configured to store the encoded video data output from the network interface, and a buffer control unit configured to adjust sizes of the first buffer and the second buffer, and buffer the audio data and the video data in the first buffer and the second buffer.

The control unit may check time information about each of the decoded audio data and the decoded video data, and may transmit time difference information to the buffer control unit when a time difference between the decoded audio data and the decoded video data is greater than a preset threshold value, and the buffer control unit may adjust a size of one of the first buffer and the second buffer based on the time difference information so that the time difference is less than or equal to the preset threshold value.

The network interface may receive the encoded audio data over a first communication network and receive the encoded video data over a second communication network.

The client apparatus may further include a network state check unit configured to periodically check a state of the communication networks, wherein the control unit adjusts a size of one of the first buffer and the second buffer through the buffer control unit depending on a check result of the network state check unit, or adjusts a decoding speed of one of the first decoder and the second decoder.

In accordance with another aspect of the present disclosure to accomplish the above object, there is provided a cloud streaming processing method in a client apparatus, including receiving encoded audio data, encoded video data, and a control signal in a separated state, decoding the received encoded audio data based on the control signal, decoding the received encoded video data based on the control signal, and outputting the decoded audio data and the decoded video data through a user interface.

The cloud streaming processing method may further include checking playback time information about each of the decoded audio data and the decoded video data to compare a time difference between the decoded audio data and the decoded video data, and adjusting one of a decoding speed of audio data and a decoding speed of video data when the time difference between the decoded audio data and the decoded video data is greater than a preset threshold value.

The cloud streaming processing method may further include buffering the encoded audio data output from a network interface through a first buffer, buffering the encoded video data output from the network interface through a second buffer, checking playback time information about each of the decoded audio data and the decoded video data to compare a time difference between the decoded audio data and the decoded video data, and adjusting sizes of the first buffer and the second buffer.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic block diagram of a cloud streaming service system according to the present disclosure;

FIG. 2 is a schematic block diagram of a typical client;

FIG. 3 is a schematic block diagram of a cloud streaming server according to an embodiment of the present disclosure;

FIG. 4 is a schematic block diagram of a client according to an embodiment of the present disclosure;

FIG. 5 is a flowchart for explaining an example cloud streaming low latency playback processing method in a client according to an embodiment of the present disclosure;

FIG. 6 is a flowchart for explaining another example cloud streaming low latency playback processing method in a client according to an embodiment of the present disclosure;

FIG. 7 is a schematic block diagram of a client according to another embodiment of the present disclosure;

FIG. 8 is a flowchart for explaining an example cloud streaming low latency playback processing method in a client according to another embodiment of the present disclosure;

FIG. 9 is a schematic block diagram of a client according to another embodiment of the present disclosure;

FIG. 10 is a flowchart for explaining an example cloud streaming low latency playback processing method in a client according to another embodiment of the present disclosure; and

FIG. 11 illustrates an operating environment of an apparatus for the configuration of a cloud streaming service providing method according to an embodiment of the present disclosure.

### DESCRIPTION OF THE PREFERRED EMBODIMENTS

To make the features and advantages of the present disclosure more clear, the present disclosure will be described in more detail with reference to specific embodiments shown in the accompanying drawings.

In describing the present disclosure, a detailed description of known functions and configurations will be omitted when it may obscure the subject matter of the present disclosure. In addition, it will be noted that like reference numerals refer to like or similar elements throughout the drawings.

The terms or words used in the specification and drawings should not be construed as limiting to mean typically or lexically, but are to be construed to mean in context with the technical idea of the present disclosure based on the principle that an inventor can define the concept of an object or thought properly to best describe the disclosure in mind. Therefore, the configuration shown in the drawings and the embodiments described herein are merely an example embodiment of the present disclosure, and it should be understood that there are various modifications and equivalents for substituting the disclosure at the present time of this application.

In addition, such terms as “first” and “second” may be used to explain various components and to simply distinguish a corresponding component from another, and do not limit the components. For example, without departing from the scope of the present disclosure, a second element may be referred to as a first element, and similarly, a first element may be referred to as a second element.

In addition, when an element is referred to as being “connected to” or “accessing” another element, the element may be logically or physically connected or access. In other words, an element may be directly connected to or access another element, but it should be understood that there may be an intervening element therebetween, or the element may be indirectly connected or access.

In addition, the terminology used herein is for the purpose of describing particular embodiments only and is not intended to be limiting of the present disclosure. Singular expressions include plural expressions unless the context clearly indicates otherwise. It should be understood that the terms “include” or “have” used in the detailed descriptions indicate existence of features, numbers, steps, operations, components, parts or a combination thereof described in the detailed descriptions, and do not preclude the presence or addition of one or more other features, numbers, steps, operations, components, parts or combinations thereof.

In addition, embodiments within the scope of the present disclosure include computer-readable media having or transferring computer-executable instructions or data structures stored in the computer-readable media. Such computer-readable media may be any available media accessible by a general purpose or special purpose computer system. By way of example, such computer readable media may be in the form of RAM, ROM, EPROM, CD-ROM or other optical disk storage, magnetic disk storage or other magnetic storage, or computer executable instructions, computer readable instructions, or data structures. It may include, but is not limited to, physical storage media such as any other media that may be used to store or deliver certain program code means, and may be accessed by a general purpose or special purpose computer system.

Computer-readable instructions include, for example, instructions and data that cause a general purpose computer system or a special purpose computer system to perform a specific function or group of functions. Computer-executable instructions may be, for example, assembly language, or even binary, intermediate format instructions such as source code.

The present disclosure may be practiced in network computing environments with many types of computing system configurations, including, personal computers, laptop computers, hand-held apparatuses, multi-processor systems, microprocessor-based or programmable consumer electronics, network PCs, minicomputers, mainframe computers, mobile telephones, PDAs, pagers, or the like. The present disclosure may also be practiced in distributed system environments where local and remote computing systems, which are linked by hardwired data links, wireless data links, or by a combination of hardwired and wireless data links through a network, both perform tasks. In a distributed system environment, program modules may be located in local and remote memory storage devices.

The present disclosure is intended to reduce unnecessary latency according to demultiplexing and synchronization by receiving and decoding audio data and video data separately in processes of decoding encoded media data to output media data, and may be applied to an apparatus and service including an image output function.

For example, the present disclosure may be applied to a cloud streaming service in which a server side executes a game, a VOD, a real-time broadcast content or the like and transmits the execution screen to a client in a streaming manner, and a client side performs only an input and output.

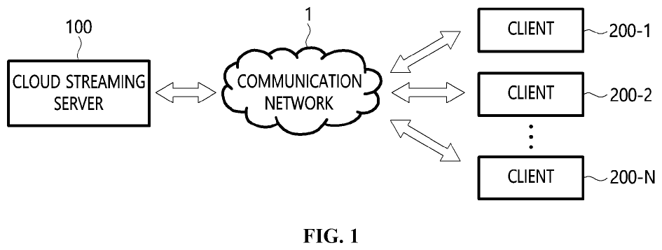

First, FIG. 1 is a schematic block diagram of a cloud streaming service system according to the present disclosure.

Referring to FIG. 1, the cloud streaming service system according to the present disclosure may be configured of a cloud streaming server 100 and one or more clients 200-1, 200-2, . . . , and 200-N.

In addition, a communication network 1 may be included to support transmission and reception of information between the cloud streaming server 100 and the one or more clients 200-1, 200-2, . . . , and 200-N.

Briefly describing each of the components, the clients 200-1, 200-2, . . . , and 200-N mean user apparatuses that may transmit and receive various kinds of data over the communication network 1 according to user operations, perform data communication over the communication network 1, and access the cloud streaming server 100 to receive various kinds of information provided by the cloud streaming server 100 in a cloud streaming service manner, and transmit user inputs to the cloud streaming server 100.

To this end, the clients 200-1, 200-2, . . . , and 200-N each may include a browser for information transmission and reception, a memory configured to storing programs and protocols, a microprocessor for executing various kinds of programs to perform calculations and controls, or the like.

In particular, the clients 200-1, 200-2, . . . , and 200-N according to embodiments may perform connection to the cloud streaming server 100 over the communication network 1 to request to execute specific data among a lot of data provided by the cloud streaming server 100, and receive result information according to the data execution from the cloud streaming server 100 in the streaming manner. Accordingly, the corresponding user of the clients 200-1, 200-2, . . . or 200-N may use the data.

Here, the actual data is executed in the cloud streaming server 100 located remotely from the clients 200-1, 200-2, . . . , and 200-N, but the corresponding user of the clients 200-1, 200-2, . . . , and 200-N may use the same content data as if the data were executed in the user's own clients 200-1, 200-2, . . . , and 200-N.

Here, the data may be the concept including a UI application like, for example, a menu application.

Each of such clients 200-1, 200-2, . . . , and 200-N of the present disclosure may basically include a function of receiving to decode encoded streaming data, and further include a function of rendering the decoded video data to output the rendered data.

Each of the clients 200-1, 200-2, . . . , and 200-N receives, from the cloud streaming server 100, a screen of an application execution result corresponding to the cloud streaming service to provide the screen to the users.

Accordingly, as each of the clients 200-1, 200-2, . . . , and 200-N for processing the aforementioned cloud streaming service, any one of various information communication devices used by the user is possible if the communication device may communicate over the communication network 1.

For example, each of the clients 200-1, 200-2, . . . , and 200-N is not limited to a mobile terminal, but may be one of various kinds of terminals such as all kinds of information communication devices, multimedia terminals, wired terminals, fixed terminals, fixed terminals, Internet Protocol (IP) terminals or the like.

In addition, each of the clients 200-1, 200-2, . . . , and 200-N may be a mobile terminal having various mobile communication specifications including a mobile phone, a Portable Multimedia Player (PMP), Mobile Internet Device (MID), a smartphone, a desktop computer, a tablet computer, a notebook, a netbook, a Personal Digital Assistant (PDA), an information communication device or the like.

In addition, each of the clients 200-1, 200-2, . . . , and 200-N may be a set-top box that may perform connection to the communication network 1 to receive and replay IPTV broadcast data, or a smart TV for supporting a broadcast function and an Internet service over the communication network 1.

Moreover, in an embodiment of the present disclosure, the clients 200-1, 200-2, . . . , and 200-N may be divided into ones including an image output means and ones not including the image output means.

Here, each of the clients 200-1, 200-2, . . . , and 200-N including the image output means may correspond to a smartphone, a notebook, a desktop PC, a tablet PC, a smart TV or the like, and each of the clients 200-1, 200-2, . . . , and 200-N not including the image output means may correspond to a set-top box or the like.

The cloud streaming server 100 provides the cloud streaming service of the present disclosure and serves to provide a service or function, requested from one of the clients 200-1, 200-2, . . . , and 200-N, to the one of clients 200-1, 200-2, . . . , and 200-N through a screen virtualization function.

Here, the screen virtualization means to implement an execution screen of specific data, such as being executed in one of the clients 200-1, 200-2, . . . , and 200-N, in a server side, that is, the cloud streaming server 100 connected over the communication network 1 to provide the execution screen to the one of the clients 200-1, 200-2, . . . , and 200-N.

To this end, the cloud streaming server 100 executes various pieces of data held in or available to it, for example a UI application, a game application or the like, captures the execution screen thereof in units of browser to generate a captured image, and then encodes the captured image to transmit the encoded image to the one of the clients 200-1, 200-2, . . . , and 200-N in a streaming manner.

Here, the cloud streaming server 100 drives the data according to a user input transmitted from one of the clients 200-1, 200-2, . . . , and 200-N, and transmits the changed execution screen to the one of the clients 200-1, 200-2, . . . , and 200-N in the streaming manner. The user of the one of the client 200-1, 200-2, and 200-N may receive the user experience that is the same that the data is directly executed in the user's own apparatus.

To this end, the cloud streaming server 100 executes or plays back preset content according to a request from one of the client 200-1, 200-2, . . . , and 200-N, and encodes audio data and video data corresponding to the result to transmit the encoded data to the one of the client 200-1, 200-2, . . . , and 200-N over the communication network 1.

The communication network 1 is to provide routes for transferring data between the cloud streaming server 100 and the clients 2001, . . . , 200-N, and cover all of the existing network and a network that may be developed in the future.

That is, the communication network 1 may be any one or a combination of two or more of wired and wireless short-range communication networks, a mobile communication network for providing communications between mobile bodies and between the mobile bodies and the outside of the mobile bodies, a satellite communication network providing communications between earth stations using satellites or a wired and wireless communication network. For example, the communication network 1 may be a combination of communication networks according to at least one of a wireless communication method including a Wireless LAN (WLAN), Wi-Fi, Wibro, or Wimax, a mobile communication method including High Speed Downlink Packet Access (HSDPA), CDMA, Long Term Evolution or the like, or a wired communication method including xDSL (ADSL, VDSL), Hybrid Fiber Coax (HFC), Fiber to The Curb (FTTC), or Fiber To The Home (FTTH), or a combination thereof.

Meanwhile, the standard transmission method of the network 130 is not limited to the existing standard transmission method, but may include all standard transmission methods to be developed in the future.

In addition, the communication network 1 used between the cloud streaming server 100 and the clients 200-1, . . . , and 200-N may be different from or the same as a network used between the clients 200-1, . . . , and 200-N.

However, when the cloud streaming server 100 performs transmission to the clients 200-1, . . . , and 200-N over the communication network 1, video data and audio data are typically generated in the format of MP4 or the like to generate MP4, TS, or MKV files to be transmitted.

Here, the MP4 is the standard of a compressed file and multimedia container format based on the MPEG-4 technique developed by the Moving Picture Experts Group (MPEG). From multimedia data applied with the MPEG technique, an image and voice of high quality may be generated with a smaller capacity than that with MPEG-1 and MPEG-2, and is suitable for using in a mobile device with a small storage space because of the small capacity. In addition, streaming over the Internet is also supported.

The MKV is an open standard container format as an open computer file format developed by Matroska. The MKV is a file format that may contain an unlimited number of video, audio, picture, and subtitle tracks in one file. The MKV uses extensible binary meta language (EBML) instead of the binary format used in other codecs, the function of which is similar to AVI, MP4, ASK or the like. The Matroska multimedia container means the format containing video and audio data based on the traditional Russian dolls which open to expose another smaller doll, and in turn open to expose another doll, and so on. The MKV is a file format that may bind various images, voices, and subtitle files into one, is developed as a universal format for containing multimedia content such as a video, a drama or the like, and is a complete open source that is more open than AVI. However, an MKV file created with a codec, not supported by a player, is not played back.

When using such a format, it becomes easy to synchronize audio data and video data or to display additional information.

However, when cloud streaming data generated in such a format is received, the typical clients 200-1, . . . , and 200-N separate data in a format like MP4 into audio data, video data, and time information, synchronize them, and play them back on a screen.

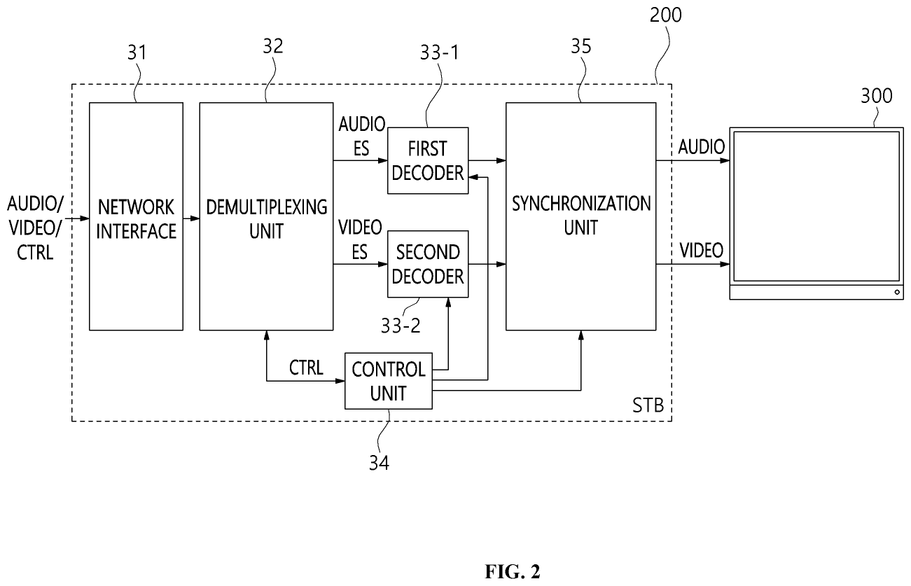

FIG. 2 is a schematic block diagram of a typical client.

That is, referring to FIG. 2, when each of typical clients 200-1, . . . , or 200-N receives data in a format like MP4 including audio data, video data, and a control signal through a network interface 31, the corresponding client separates the data into audio data and video data through demultiplexing 32, parses the header to decode 33-1 and 33-2 the audio data and the video data, synchronizes 35 the playback time of the video data and the audio data, and then outputs an image and voice through rendering. Here, the image and voice outputs are delayed by an amount of time required for the demultiplexing and synchronization and thus the latency of the user is increased.

Accordingly, for reducing the latency of the user to improve the service quality, the present disclosure intends to minimize the amount of time required for the demultiplexing and synchronization.

Namely, in an embodiment of the present disclosure, in transmitting the encoded video data and audio data to the client 200-1, 200-2, . . . , and 200-N, the cloud streaming server 100 does not multiplex the encoded video data and audio data, and a control signal of the content requested from one of the client 200-1, 200-2, . . . , or 200-N to generate one piece of data in the format of MP4 or the like, but separates them to transmit the separated pieces of data. That is, the cloud streaming server 100 encodes the video and audio data in units of frame, and transmits, to the one of the client 200-1, 200-2, . . . , and 200-N, the encoded video data and audio data as bitstreams as they are without multiplexing.

Here, according to an embodiment of the present disclosure, the cloud streaming server 100 may synchronize the encoded video data and audio data of the requested content to transmit the synchronized data. Then, the one of the client 200-1, 200-2, . . . , and 200-N may access the cloud streaming server 100, and, when receiving each piece of the video data and audio data encoded in units of frame synchronized with the playback time from the cloud streaming server 100, decode the received video data and audio data as soon as they are received without demultiplexing and synchronization.

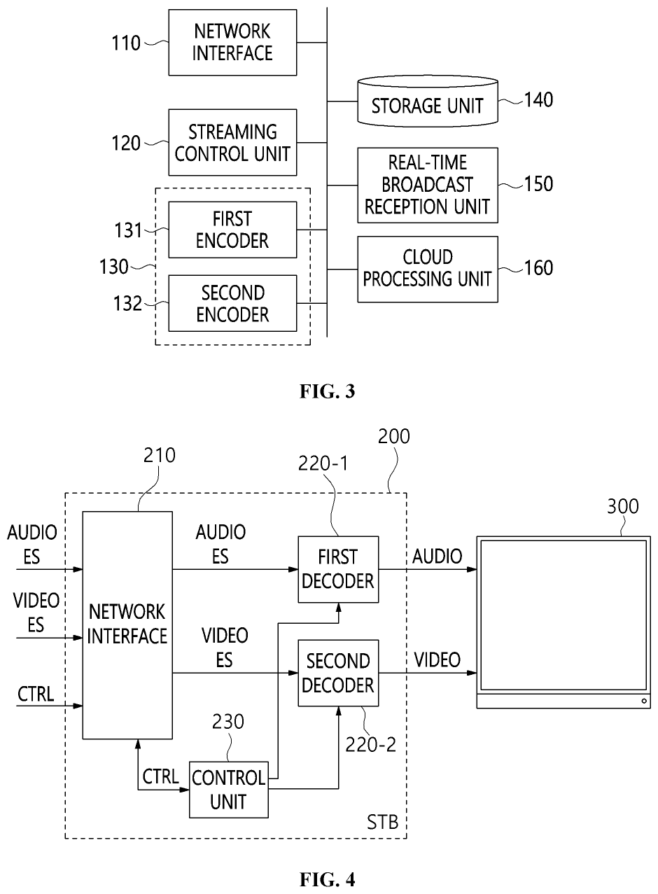

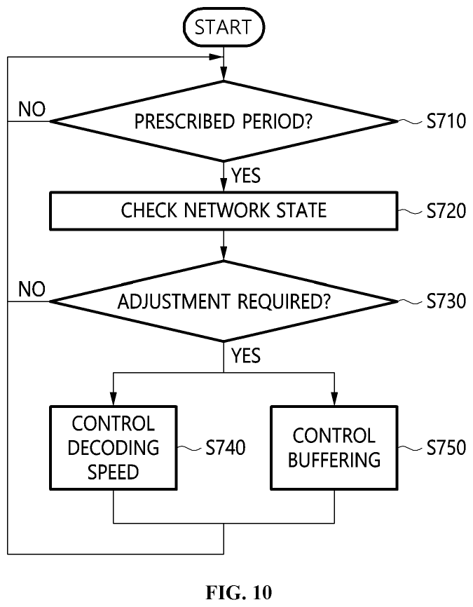

Hereinafter, referring to FIGS. 3 and 10, the configuration and operations of each apparatus of a cloud streaming service system according to the present disclosure will be described in detail.

FIG. 3 is a schematic block diagram of a cloud streaming server according to an embodiment of the present disclosure.

Referring to FIGS. 1 and 3, the cloud streaming server 100 according to the present disclosure may include a network interface 100, a streaming control unit 120, an encoder 120, a storage unit 130, a real-time broadcast reception unit 150, and a cloud processing unit 160.

The network interface 110 is a component for communicating with one or more clients 200-1, 200-2, . . . , and 200-N over a communication network 10. Such a network interface 100 may transmit and receive data based on one or more transmission protocols.

Specifically, the network interface 110 may establish a communication channel with one of the client 200-1, 200-2, . . . , and 200-N requested a service, and identify encoded video data, encoded audio data, and a control signal of the requested content to transmit the divided result to the client 200-1, 200-2, . . . , and 200-N through the established communication channel.

Here, the network interface 110 in an embodiment of the present disclosure may establish two communication channels with the clients 200-1, 200-2, . . . , and 200-N, and then transmit the encoded video data and audio data through the allocated communication channels. Here, the control signal may be transmitted in advance or together through one of the two channels, or through another separate channel. Accordingly, the clients 200-1, 200-2, . . . , and 200-N may identify the video data and audio data based on the communication channel.

In addition, in another embodiment of the present disclosure, the network interface 110 may transmit identifiers, which identify the data types, for example, the video data, the audio data, and the control signal, together with the encoded video data and audio data, and the control signal. In this case, the client 200-1, 200-2, . . . , and 200-N may identify the video data, the audio data, and the control signal using the identifiers included in the received data.

Next, a streaming control unit 120 is for a transmission process in the cloud streaming service.

Specifically, the streaming control unit 120 transmits, together with the control signal, the encoded video and audio data of the content requested by one of the client 200-1, 200-2, . . . , and 200-N according to the service request from the one of the client 200-1, 200-2, . . . , and 200-N connected over the network interface 110. In particular, the streaming control unit 120 according to the present disclosure may transmit, to the client, the encoded video data and audio data in synchronization with each other, wherein the encoded video data and audio data are not transmitted in advance before playback, but the video data and audio data encoded in units of frame may be sequentially transmitted in synchronization with the playback time in the client.

In particular, the streaming control unit 120 according to the present disclosure transmits the encoded bitstreams as they are without packetization and multiplexing for the encoded video data and audio data.

In addition, the streaming control unit 120 may include the identifiers, which identify the data type, in the encoded video data and audio data, and the control signal so that the data received in the client can be identified to be the video data or audio data.

Next, an encoder 130 is a component for generating the encoded video data and audio data.

That is, the encoder 30 encodes the video data and audio data of the content requested from the client according to a preset compression protocol. Here, video data and audio data compression methods may be different from each other. According to an embodiment, the encoder 130 may include a first encoder 131 configured to encode the audio data and a second encoder 132 configured to encode the video data.

In addition, the encoder 130 may perform encoding by being transferred with the video data and audio data from at least one of the storage unit 140, the real-time broadcast reception unit 150, and the cloud processing unit 160.

The storage unit 140 is a component for storing data and programs required for the operations of the cloud streaming server 100 according to the present disclosure, and may store programs and pieces of data for executing a service. More specifically, the storage unit 140 may store content data to be serviced to the client. Here, the content data may include the video data and audio data prior to the encoding, and in some cases, the content data may include the encoded video data and audio data.

Furthermore, the cloud streaming server 100 according to the present disclosure may service content broadcast in real time to the client.

To this end, the real-time broadcast reception unit 150 may receive the content broadcast in real time from an external apparatus, for example, a broadcast service apparatus such as a CATV or IPTV.

As described above, the cloud streaming service is a service in which a server side instead executes or plays back the content requested by the user and then transmits the result (video data and audio data) to the client 200-1. 200-2, . . . , and 200-N.

To this end, the cloud streaming server 100 according to the present disclosure may further include a cloud processing unit 160.

The cloud processing unit 160 instead executes or plays back the content requested by the client and then outputs video data and/or audio data generated according thereto. Here, the cloud processing unit 160 may executes or plays back the content according to an input signal transmitted from the client.

For example, when the content requested by one of the client 200-1, 200-2, and 200-N includes an application such as a game, the content is executed in the cloud processing unit 160, the resulting video data and audio data are encoded through the encoder 130, and then the encoded data is transmitted to the one of the client 200-1, 200-2, . . . , and 200-N through the streaming control unit 120.

For another example, when the content requested by one of the client 200-1, 200-2, . . . , and 200-N includes real-time broadcast, the content is received by the real-time broadcast reception unit 150 to be encoded through the encoder 130, and then the encoded result is transmitted to the one of the client 200-1, 200-2, . . . , and 200-N through the streaming control unit 120.

Furthermore, the content requested by the one of the client 200-1, 200-2, . . . , and 200-N may include one or more different kinds of content. For example, real-time broadcast or a chat application may be included. Accordingly, the cloud processing unit 160 may mix one or more content outputs from the storage unit 140 to output the mixed result.

Accordingly, the cloud streaming server 100 provides the cloud streaming service according to the present disclosure through the interaction between two or more components among the service communication unit 100, the streaming control unit 120, the encoder 130, the storage unit 140, the real-time broadcast unit 150, and the cloud processing unit 160.

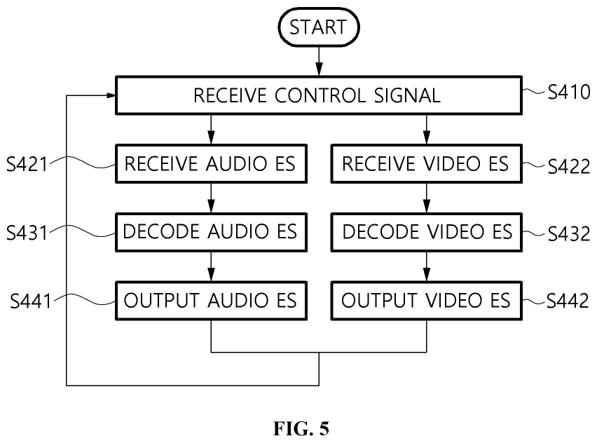

FIG. 4 is a schematic block diagram of a client according to an embodiment of the present disclosure. For reference, FIG. 4 illustrates only components related to the present disclosure, and the client 200 may include other components except the shown components. Moreover, each of the components shown in FIG. 4 may be implemented with software, hardware, or a combination of software and hardware, and may be understood as the same component regardless of the implemented type or the name if the function disclosed below is performed.

In an embodiment of the present disclosure, as shown in FIG. 4, the client 200 may include a network interface 210, a first decoder 220-1, a second decider 220-2, and a control unit 230.

The network interface 210 may be a component for performing connection to the cloud streaming server 100 over the communication network and receiving data.

The network interface 210 may include the encoded video data Video ES and audio data Audio ES, and the control signal Ctrl corresponding to the user request from the cloud streaming server 100.

Here, each of the encoded audio data and video data and the control signal may be separately received.

More specifically, the network interface 210 may first transfer the control signal to the control unit 230, receive the video data and audio data encoded in units of frame separately in synchronization with the playback time, and identify the received video data and audio data to separately transfer them to the first decoder 220-1 and the second decoder 220-2.

Here, the network interface 210 does not perform demultiplexing on the received data, but identifies whether the received data is video data or audio data to transfer the data to the first decoder 220-1 or the second decoder 220-2 at it is.

In an embodiment of the present disclosure, the network interface 210 may separately receive the encoded video data and audio data through different communication channels to identify the audio data and the video data based on the communication channels. Here, the control signal may be transmitted in advance or together through one of the two channels, or through another separate channel.

In addition, in another embodiment of the present disclosure, as the network interface 210 receives the video data, the audio data, and the control signal including the respective identifiers that identify the data types, the network interface 210 may identify the video data, the audio data and the control signal using the identifiers included in the data.

The first decoder 220-1 decodes the encoded video data according to a decoding algorithm.

The second decoder 220-2 decodes the encoded audio data according to a decoding algorithm.

In particular, the first decoder 220-1 and the second decoder 220-2 decodes the encoded video data and audio data and output the decoded data as soon as receiving the data without separate synchronization. Here, the encoded video data and audio data received by the network interface 210 are transmitted in synchronization with the playback time in units of frame, and thus, the video data and audio data may be synchronized to be output in synchronization with the playback time without a separate synchronization process between the video decoding unit 220 and the audio decoding unit 230.

Finally, the control unit 230 may control the first decoder 220-1 and the second decoder 220-2 based on the control signal output from the network interface 110, and control so that the audio data and video data respectively output from the first decoder 220-1 and second decoder 220-2 nay be played back through the user interface.

Here, when the client 200 includes an image output means, for example, an LCD display or the like, the client 200 may render the decoded video data to output the rendered image.

Moreover, as shown in FIG. 4, the client 200 may be a set-top box STB not including its own image output means. In this case, the client 200 may perform only reception and decoding functions on the encoded audio data and video data, and the control signal, and transmit the decoded video data to another image output apparatus 300 to output the data through the image output apparatus 300. In this case, the rendering process of the decoded video data may be performed through the separate image output apparatus 300.

In this case, the client 200 may further include a connection interface unit (not shown) that may be connected to the image output apparatus 300, and the video data and audio data respectively decoded in the first decoder 220-1 and the second decoder 220-2 may be output to the image output apparatus 300 through the connection interface unit.

Here, the connection interface unit is a component for connecting the client 200 and the image output apparatus 300 to transfer data, and may be implemented with an interface with a preset specification, such as High definition multimedia interface HDMI, Digital Visual Interface (DVI) or the like.

Here, the image output apparatus 300 means an apparatus having an image output function, for example, a monitor, a TV, a projector, or the like.

Such an image output apparatus 300 may be transferred with and render the decoded video data, and output the image on the screen. Here, the image output apparatus 300 may also include the connection interface unit (not shown), be connected to the client according to the same interface specification as the connection interface unit provided in the client 200, and transmit and receive the control signal and the data.

Typically, the rendering means a process of composing an image of a preset resolution from image data through a computer program, and is to calculate the encoded image data as digital pixel values of primary colors represented in an image output means and compose an output image corresponding to the image data in the image output means.

However, when each of the decoded audio data and video data is output through the user interface, an asynchronous phenomenon between the pieces of data may occur due to various causes. When such a phenomenon continues, the difference between the playback time of the audio data and video data increases and thus the quality of the cloud streaming service may be lowered.

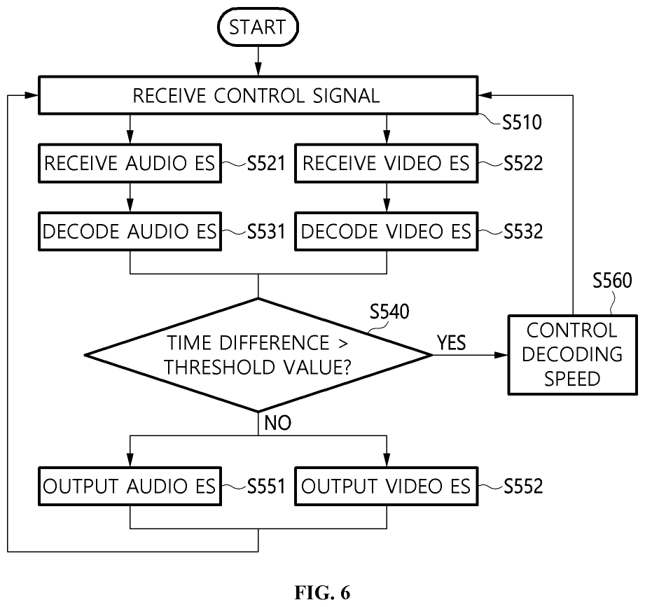

Accordingly, the control unit 20 may check each piece of time information about the decoded audio data and video data, and additionally perform the operation for reducing the time difference depending on the check result. Detailed description thereof will be provided below with reference to FIG. 6.

FIG. 5 is a flowchart for explaining an example cloud streaming low latency playback processing method in a client according to an embodiment of the present disclosure, and FIG. 6 is a flowchart for explaining another example cloud streaming low latency playback processing method in a client according to an embodiment of the present disclosure.

Referring to FIG. 5, first, the network interface 210 of the client 200 transfers the control signal to the control unit 230 according to reception of the control signal over the communication network 1 at step S410.

Then, the network interface 210 of the client 200 concurrently receives the encoded audio signal and the encoded video signal at steps S421 and S422.

In an embodiment of the present disclosure, the network interface 210 may separately receive the encoded video data and audio data through different communication channels to identify the audio data and the video data based on the communication channels.

Alternatively, in another embodiment of the present disclosure, as the video data, the audio data, and the control signal including the identifiers that identify the data types are received, the video data and the audio data may be identified using the identifiers included in the data.

Then, the control unit 230 of the client 200 controls the first decoder 220-1 to decode the encoded audio data according to the control signal at step S431.

In addition, the control unit 230 of the client 200 controls the second decoder 220-2 to decode the encoded video data according to the control signal at step S432.

Then, the control unit 230 of the client 200 controls the audio data and video data respectively output from the first decoder 220-1 and the second decoder 220-2 to be played back through the user interface at steps S441 and S442.

Here, when the client 200 includes an image output means, for example, an LCD display or the like, the client 200 may render the decoded video data to output the rendered image.

In addition, the client 200 may not include its own image output means. In this case, the client 200 may perform only reception and decoding functions for the bitstream including the encoded video data, and transmit the decoded video data to another image output apparatus to output the data through the image output apparatus. In this case, the rendering process for the decoded video data may be performed through the separate image output apparatus.

In the present disclosure, the control unit 230 of the client 200 may check each piece of time information about the decoded audio data and video data, and additionally perform the operation for reducing the time difference depending on the check result.

In other words, referring to FIG. 6, the control unit 230 of the client 200 checks each piece of time information about the decoded audio data and video data, and determines whether the time difference between the decoded audio data and video data is less than or equal to a preset threshold value at step S540. Here, step S540 may not be continuously performed, but be performed in a preset period.

When the time difference between the decoded audio data and video data is less than or equal to the preset threshold value as the result of step S540, the control unit 230 of the client 200 controls the audio data and video data respectively output from the first decoder 220-1 and the second decoder 220-2 to be played back through the user interface at steps S551 and S552.

On the contrary, when the time difference between the decoded audio data and video data is greater than the preset threshold value as the result of step S540, the control unit 230 of the client 200 adjusts the decoding speed of one of the first decoder 220-1 and the second decoder 220-2 at step S560, and then proceeds to step S510.

Here, steps S540 and S550 may be concurrently performed several times while steps S510 to S552 are performed. Through this, synchronization without delay or seamless synchronization may be gradually performed according to the synchronization of the streaming service.

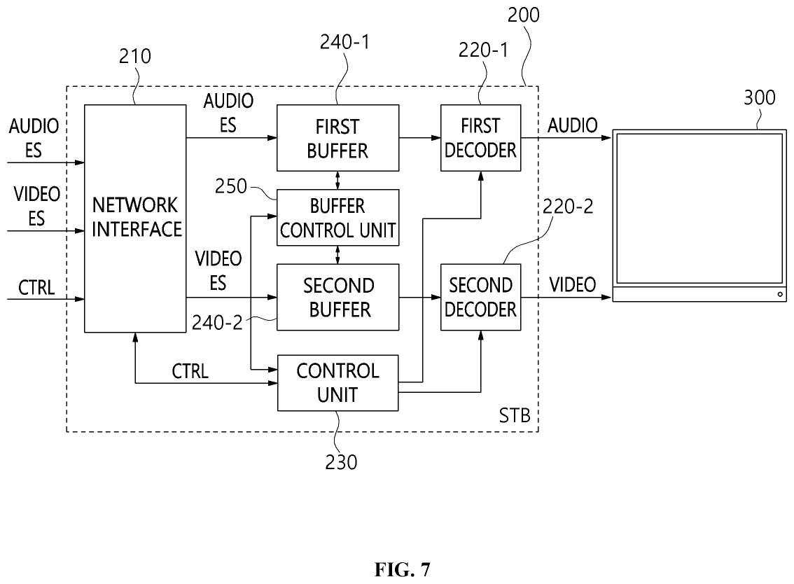

FIG. 7 is a schematic block diagram of a client according to another embodiment of the present disclosure. For reference, FIG. 7 illustrates only components related to the present disclosure, and the client 200 may include other components other than the shown components. Moreover, each of the components shown in FIG. 7 may be implemented with software, hardware, or a combination of software and hardware, and may be understood as the same component regardless of the implemented type or the name if the function disclosed below is performed.

In an embodiment of the present disclosure, as shown in FIG. 7, the client 200 may include a network interface 210, a first decoder 220-1, a second decider 220-2, a control unit 250, a first buffer 240-1, a second buffer 240-2, and a buffer control unit 250.

That is, other than the configuration of the client shown in FIG. 4, the first buffer 240-1, the second buffer 240-2, and the buffer control unit 250 are further included. Accordingly, hereinafter, detailed description of the same components shown in FIG. 4 will be omitted, and the additional components will be mainly described.

First, the network interface 210 may transfer the control signal to the control unit 230, receive the video data and audio data encoded in units of frame in synchronization with the playback time, and identify the received video data and audio data to separately transfer them to the first decoder 240-1 and the second decoder 240-2.

Here, the network interface 210 does not perform demultiplexing on the received data, but identifies whether the received data is video data or audio data to transfer the data to the first decoder 240-1 or the second decoder 240-2 as it is.

The buffer control unit 250 may adjust the sizes of the first buffer 240-1 and the second buffer 240-2 according to the time difference between the audio data and the video data.

The first decoder 220-1 decodes the encoded video data stored in the first buffer 240-1 according to a decoding algorithm. The second decoder 220-2 decodes the encoded audio data stored in the second buffer 240-2 according to a decoding algorithm.

The control unit 230 checks each piece of time information about the decoded audio data and video data, and determines whether the time difference between the decoded audio data and video data is less than or equal to a preset threshold value. This may not be continuously performed, but be performed in a preset period.

When the time difference between the decoded audio data and the decoded video data is less than or equal to the preset threshold value, the control unit 230 controls the audio data and video data respectively output from the first decoder 220-1 and the second decoder 220-2 to be played back through the user interface.

On the contrary, the control unit 230 may adjust the size of one of the first buffer 240-1 and the second buffer 240-2 when the time difference between the encoded data and video data is greater than the preset threshold value. According to another embodiment, the control unit 230 may perform an operation for adjusting the decoding speed shown in FIG. 6 instead of adjusting the size of the buffer, or concurrently adjust the buffer size and the decoding speed.

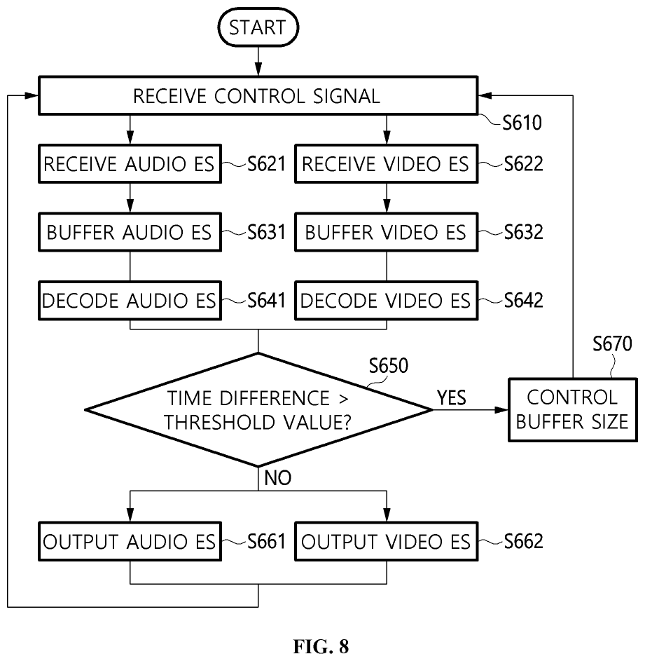

FIG. 8 is a flowchart for explaining a cloud streaming low latency playback processing method in a client according to another embodiment of the present disclosure. Hereinafter, detailed description of the same components shown in FIGS. 5 and 6 will be omitted, and the additional components will be mainly described.

Referring to FIG. 8, the network interface 210 of the client 200 first transfers a control signal to the control unit 230 according to reception of the control signal over the communication network 1 at step S610.

Then, the network interface 210 of the client 200 concurrently receives the encoded audio signal and the encoded video signal at steps S621 and S622.

Then, the encoded audio signal and the encoded video signal are respectively stored in the first buffer 240-1 and the second buffer 240-2 of the client 200 at steps S631 and S632.

Then, the control unit 230 of the client 200 controls the first decoder 220-1 to decode the audio data according to the control signal at step S641. In addition, the control unit 230 of the client 200 controls the second decoder 220-2 to decode the video data according to the control signal at step S642.

The control unit 230 of the client 200 checks each piece of time information about the decoded audio data and video data, and determines whether the time difference between the decoded audio data and video data is less than or equal to the preset threshold value at step S650. Here, step S650 may not be continuously performed, but be performed in a preset period.

When the time difference between the decoded audio data and the decoded video data is less than or equal to the preset threshold value as the result of step S650, the control unit 230 of the client 200 controls the audio data and video data respectively output from the first decoder 220-1 and the second decoder 220-2 to be played back through the user interface at steps S661 and S662.

On the contrary, when the time difference between the decoded audio data and decoded video data is greater than the preset threshold value as the determination result at step S650, the control unit 230 of the client 200 adjusts the size of one of the first buffer 240-1 and the second buffer 240-2 at step S670. Then, the process returns to step S610.

Here, steps S650 and S660 may be concurrently performed several times while steps S610 to S662 are performed. Through this, synchronization without delay or seamless synchronization may be gradually performed according to the synchronization of the streaming service.

Meanwhile, step S670 may be optionally replaced with adjusting the decoding speed shown in FIG. 6 or the buffer size control and the decoding speed adjustment may be concurrently performed.

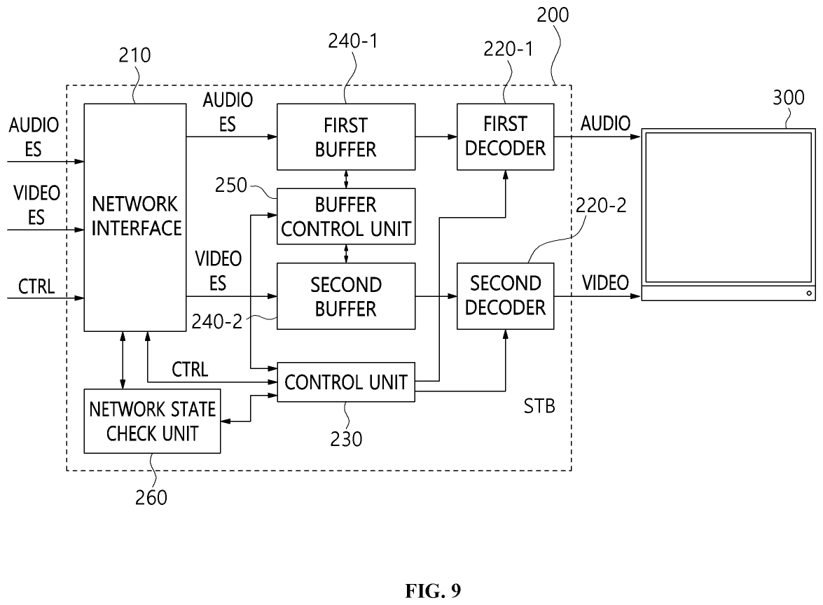

FIG. 9 is a schematic block diagram of a client according to another embodiment of the present disclosure. For reference, FIG. 9 illustrates only components related to the present disclosure, and the client 200 may include other components other than the shown components. Moreover, each of the components shown in FIG. 9 may be implemented with software, hardware, or a combination of software and hardware, and may be understood as the same component regardless of the implemented type or the name if the function disclosed below is performed.

In an embodiment of the present disclosure, as shown in FIG. 7, the client 200 may include a network interface 210, a first decoder 220-1, a second decider 220-2, a control unit 230, a first buffer 240-1, a second buffer 240-2, a buffer control unit 250, and a network condition confirmation unit 260.

That is, the network state check unit 260 is further included in the configuration of the client 200 shown in FIG. 7. Accordingly, hereinafter, detailed description of the same components shown in FIG. 7 will be omitted, and the additional components will be mainly described.

The network interface 210 may receive, from the cloud streaming server, the encoded video data Video ES, the audio data Audio ES, and a control signal Ctrl corresponding to the user request.

Here, each of the encoded audio data, the encoded video data and the control signal may be separately received.

According to an embodiment, the encoded audio data and the encoded video data may be transmitted through different channels. For example, the audio data may be transmitted through a channel allocated with a bandwidth smaller than that of the video data. Here, the network interface 210 may check each state of the channels.

In addition, according to another embodiment, each of a channel through which the encoded audio data is transmitted and a channel through which the encoded video data is transmitted may be established through different communication networks. Here, the network interface 210 may receive the encoded audio data over a first communication network and the encoded video data over a second communication network.

Accordingly, the network state check unit 260 may periodically check the network state of the channel through which the encoded audio data is transmitted and the network state of the channel through which the encoded video data is transmitted.

In addition, the network state check unit 260 may periodically check the states of the first communication network over which the encoded audio data is transmitted and the second communication network over which the encoded video data is transmitted.

According to such network states, time delays may occur when the network interface 210 receives each of the encoded audio data and the encoded video data, and thus the audio data and video data to be played back later may not be synchronized.

Accordingly, the control unit 240 may perform an operation for adjusting asynchronization depending on the check result of the network state check unit 260. Detailed description thereof is provided with reference to FIG. 10.

FIG. 10 is a flowchart for explaining a cloud streaming low latency playback processing method in a client according to another embodiment of the present disclosure.

Referring to FIG. 10, the network state check unit 260 of the client 200 checks the state of the communication networks in a preset period at steps S710 and S720.

Then, the network state check unit 260 of the client 200 determines whether adjustment for synchronization is required according to the result of the network state check at step 730.

For example, a delay or a fault may occur in one of the first communication network over which the encoded audio data is transmitted and the second communication network over which the encoded video data is transmitted. Then, data transmitted over the network of which the communication state is not good is delayed and thus the audio data and the video data may not be synchronized during playback.

Accordingly, when it is determined that the adjustment by the network state check unit 260 of the client 200 is required, the control unit 230 adjusts the decoding speed of one of the first decoder and the second decoder at step S740, or adjusts the size of one of the first buffer 240-1 and the second buffer 240-2 through the buffer control unit 250 at step S750. Alternatively, steps S740 and S750 may be simultaneously performed.

Meanwhile, the operations shown in FIG. 10 may be concurrently performed with the operations shown in FIGS. 5, 6 and 8. Through this, the synchronization without delay or seamless synchronization may be gradually performed according to the synchronization of the streaming service.

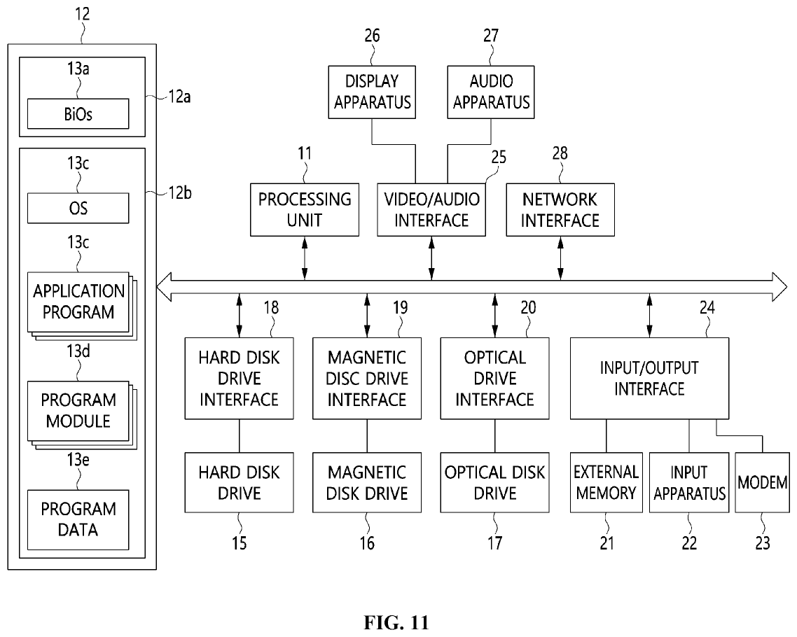

FIG. 11 illustrates an operating environment of an apparatus for the configuration of a cloud streaming service providing method according to an embodiment of the present disclosure.

FIG. 11 and the following description are intended to provide a brief, general description of a suitable computing environment in which the invention may be implemented.

Although not required, the present disclosure may be described in the context of computer-executable instructions, such as program modules, being executed by a computer system. Typically, the program modules include routines, programs, objects, components, data structures, etc., that perform particular tasks or implement particular abstract data types. Computer executable instructions, related data structures, and program modules show examples of program coding means for executing patent activities disclosed herein.

Referring to FIG. 11, an example computing system for implementing the present disclosure includes a computing apparatus including a processing unit 11, a system memory 12, and a system bus 10 that connects various system components including the system memory 12 to the processing unit 11.

The processing unit 11 may execute a computer-executable instructions designed to implement the features of the present disclosure.

The system bus 10 may be any of several types of bus structures including a local bus, a peripheral bus, and a memory bus or memory controller using any of a variety of bus architectures. The system memory 12 includes a read only memory (ROM) 12a and a random access memory (RAM) 12b. A basic input/output system (BIOS) 13a including basic routines that help transfer information between components within the computing system, such as during startup, may be stored typically in the ROM 12a.

The computing system may include a storage means including, for example, a hard disk drive 15 for reading information from or writing information to a hard disk, a magnetic disk drive 16 for reading information from or writing information to a magnetic disk, and an optical disk drive 17 for reading information from, or writing information to an optical disk, for example, a CD-ROM or another optical medium. The hard disk drive 15, the magnetic disk drive 16, and the optical disk drive 17 are connected to the system bus 10 by a hard disk drive interface 18, a magnetic disk drive interface 19, and an optical drive interface 20, respectively.

In addition, the computing system may further include an external memory 21 as a storage means. The external memory 21 may be connected to the system bus 10 through an input/output interface 24.

The drives described above and associated computer readable media read and written by the drives provide non-volatile storage of computer-executable instructions, data structures, program modules, and other data. The example environments described herein illustrate the hard disk 15, the magnetic disk 16 and the optical disk 17, but, in addition, other types of computer-readable media for storing data may be used which include magnetic cassettes, flash memory cards, DVDs, Bernoulli cartridges, RAMs, ROMs, or the like.

A program code means including one or more program modules including an operating system 13b, one or more application programs 13c, other program modules 13d, and program data 13c that are loaded and executed by the processing unit 11 may be stored in the hard disk 15, the magnetic disk 16, the optical disk 17, the ROM 12a or the RAM 12b.

In addition, the computing system may receive commands and information from a user through other input apparatuses 22 such as a keyboard, a pointing apparatus, a microphone, a joystick, a game pad, a scanner, or the like. These input apparatuses 22 be connected to the processing unit 11 through the input/output interface 24 connected to the system bus 10. These input apparatuses 22 may logically represent any of a variety of different interfaces such as, for example, a serial port interface, a PS/2 interface, a parallel port interface, a USB interface, or an Institute of Electrical and Electronics Engineers (IEEE) 1394 interface (i.e., a FireWire interface), or logically represent even combinations of other interfaces.

The input/output interface 24 is very useful

In addition, the computing system according to an embodiment of the present disclosure may further include a display apparatus 26 such as a monitor or LCD, or an audio apparatus 27 such as a speaker or microphone, and these are connected to the system bus 10 through a video/audio interface 25. For example, other peripheral output apparatuses (not shown) such as speakers and printers may also be connected to the computing system 420. The video/audio interface unit 25 may include a high definition multimedia interface (HDMI), a graphics device interface (GDI), or the like.

Further, the computing system implementing the present disclosure is connectable to a network such as, for example, an office-wide or enterprise-wide computer network, a home network, an intranet, and/or the Internet. The computer system may exchange data with external sources such as, for example, remote computer systems, remote applications, and/or remote databases over such computer networks.

To this end, the computing system to which the present disclosure is applied includes a network interface 28 for receiving data from and/or transmitting data to an external source.

Such a computing system according to the present disclosure may transmit and receive information to and from an apparatus located at a remote location through the network interface 28. For example, when the computing system mean the clients 200-1, 200-2, . . . , and 200-N, the computing system may transmit/receive information with the cloud streaming server 100 through the network interface 28. On the contrary, when the computing system mean the cloud streaming server 100, the computing system may transmit/receive information with the computing system clients 200-1, 200-2, . . . , and 200-N through the network interface 28. The network interface 28 may be represented by a logical combination of one or more software and/or hardware modules, such as, for example, a network interface card and a corresponding network driver interface specification (“NDIS”) stack.

Likewise, the computer system receives data from an external source or transmits data to the external source through the input/output interface 24. The input/output interface 24 may be connected to a modem 23 (e.g., a standard modem, a cable modem, or a digital subscriber line (“DSL”) modem) through which the external interface may receive data from and/or transmit data to the external sources.

While FIG. 10 represents a suitable operating environment for the present disclosure, the principles of the present disclosure may be employed in any system that is capable of, with suitable modification if necessary, implementing the principles of the present disclosure. The environment shown in FIG. 10 is merely example and does not represent even a small portion of the wide variety of environments in which the principles of the present disclosure may be implemented.

In addition, various pieces of information generated at the time of the cloud streaming service of the present disclosure may be stored and accessed on any computer-readable medium related to the computing system as shown in FIG. 10. For example, some of these program modules and some of the associated program data may be included in an operating system 13b, an application program 13c, a program module 13d, and/or program data 13e in order to be stored in the system memory 12.

In addition, when a mass storage apparatus such as a hard disk is connected to the computing system, these program modules and related program data may be stored in the mass storage apparatus. In a networked environment, the program modules or a portion thereof related to the present disclosure may be stored in a system memory related to a remote computer system connected through the modem 23 of the input/output interface 24 or the network interface 28, and/or a remote memory storage apparatus such as a mass storage apparatus. The execution of these modules may be performed in a distributed environment as described above.

Although this specification includes details of multiple specific implementations, the specific implementation details should not be construed as limitations on the scope of any inventions or of what may be claimed, but rather as descriptions of features specific to particular embodiments of particular inventions. Particular features that are described in this specification in the context of separate embodiments can also be implemented in combination in a single embodiment. Conversely, various features that are described in the context of a single embodiment can also be implemented in multiple embodiments separately or in any suitable sub-combination.

Further, although features may be described above as acting in particular combinations and even initially claimed as such, in some cases, one or more features from a claimed combination can be excluded from the combination, and the claimed combination may be changed to a sub-combination or variation of a sub-combination.

Also, in this specification, the operations are depicted in a particular order in the drawings, but this depiction should not be understood as requiring that the operations be performed in the particular order shown or in a sequential order, or that all illustrated operations be performed, in order to achieve desirable results. In a particular case, multitasking and parallel processing may be advantageous.

Further, the separation of various system components in the above-described embodiments should not be understood as requiring such separation in all embodiments, and it should be understood that the described program components and systems can generally be integrated together in a single software product or packaged into multiple software products. Particular embodiments of the subject matter described in this specification have been described. Other embodiments are within the scope of the following claims.

For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

This description sets forth the best mode of the present disclosure and provides examples to describe the present disclosure and to enable this skilled in the art to make and use the present disclosure. This written description does not limit the present disclosure to the precise terms set forth.

Thus, while the present disclosure has been described in detail with reference to the examples set forth above, those skilled in the art may affect alterations, modifications and variations to the examples without departing from the scope of the present disclosure.

Therefore, the scope of the present disclosure should not be determined by the described embodiments, but by the appended claims and their legal equivalents.

Accordingly, the present disclosure may minimize the latency from a user request to reception of a response in providing a cloud streaming service.

In other words, the present disclosure may prevent image and voice outputs from being delayed by an amount of time required for demultiplexing, synchronization or the like to reduce the latency of the user by receiving separated video data and audio data and then directly decoding to output them.

Moreover, various effects other than the aforementioned effects will be disclosed directly or implicitly in the following detailed description of the embodiments of the present disclosure.

The present disclosure may minimize the latency from a user request to reception of a response in providing a cloud streaming service.

That is, the present disclosure receives the video data and the audio data in a separated state and directly decodes to output the decoded result, and thus may prevent an increase of the latency of the user caused by that the video and voice outputs are delayed by an amount of time required for the multiplexing and synchronization. As the result, a response time to the user request may be minimized.

What is claimed is:

1. A client apparatus, comprising:
a network interface configured to receive encoded audio data, encoded video data, and a control signal in a separated state;
a first decoder configured to decode the encoded audio data output from the network interface;
a second decoder configured to decode the encoded video data output from the network interface; and
a control unit configured to control the first decoder and the second decoder based on the control signal output from the network interface, and control audio data and video data output respectively from the first decoder and the second decoder to be played back through a user interface.

2. The client apparatus of claim 1, wherein the control unit checks time information about each of the decoded audio data and the decoded video data, and controls the audio data and video data output respectively from the first decoder and the second decoder to be played back through the user interface when a time difference between the decoded audio data and the decoded video data is less than or equal to a preset threshold value.

3. The client apparatus of claim 1, wherein the control unit checks time information about each of the decoded audio data and the decoded video data, and adjusts a decoding speed of one of the first decoder and the second decoder when a time difference between the decoded audio data and the decoded video data is greater than a preset threshold value.

4. The client apparatus of claim 2, further comprising:
a first buffer configured to store the encoded audio data output from the network interface;
a second buffer configured to store the encoded video data output from the network interface; and
a buffer control unit configured to adjust sizes of the first buffer and the second buffer, and buffer the audio data and the video data in the first buffer and the second buffer.

5. The client apparatus of claim 4, wherein:
the control unit checks time information about each of the decoded audio data and the decoded video data, and transmits time difference information to the buffer control unit when a time difference between the decoded audio data and the decoded video data is greater than a preset threshold value, and
the buffer control unit adjusts a size of one of the first buffer and the second buffer based on the time difference information so that the time difference is less than or equal to the preset threshold value.

6. The client apparatus of claim 4, wherein the network interface receives the encoded audio data over a first communication network and receives the encoded video data over a second communication network.

7. The client apparatus of claim 6, further comprising:
a network state check unit configured to periodically check a state of the communication networks,
wherein the control unit adjusts a size of one of the first buffer and the second buffer through the buffer control unit depending on a check result of the network state check unit, or adjusts a decoding speed of one of the first decoder and the second decoder.

8. A cloud streaming processing method in a client apparatus, comprising:
receiving encoded audio data, encoded video data, and a control signal in a separated state;
decoding the received encoded audio data based on the control signal;
decoding the received encoded video data based on the control signal; and
outputting the decoded audio data and the decoded video data through a user interface.

9. The cloud streaming processing method of claim 8, further comprising:
checking playback time information about each of the decoded audio data and the decoded video data to compare a time difference between the decoded audio data and the decoded video data; and
adjusting one of a decoding speed of audio data and a decoding speed of video data when the time difference between the decoded audio data and the decoded video data is greater than a preset threshold value.

10. The cloud streaming processing method of claim 8, further comprising:
buffering the encoded audio data output from a network interface through a first buffer;
buffering the encoded video data output from the network interface through a second buffer;
checking playback time information about each of the decoded audio data and the decoded video data to compare a time difference between the decoded audio data and the decoded video data; and
adjusting sizes of the first buffer and the second buffer.
